(19) United States
(12) Patent Application Publication
(10) Pub. No.: US 2014/0198192 A1
(43) Pub. Date: Jul. 17, 2014

(54) DISPLAY DEVICE AND DISPLAY CONTROL METHOD

(71) Applicants: Masaaki Yamamoto, Tokyo (JP); Naomasa Takahashi, Chiba (JP); Yohsuke Kaji, Chiba (JP); Yoichi Hirota, Kanagawa (JP)

(72) Inventors: Masaaki Yamamoto, Tokyo (JP); Masaomi Nabeta, Tokyo (JP); Naomasa Takahashi, Chiba (JP); Yohsuke Kaji, Chiba (JP); Yoichi Hirota, Kanagawa (JP)

(73) Assignee: SONY CORPORATION, Tokyo (JP)

(21) Appl. No.: 14/239,211

(22) PCT Filed: Aug. 20, 2012
(86) PCT No.: PCT/JP2012/005197

§ 371 Date: Feb. 17, 2014

(30) Foreign Application Priority Data
Aug. 24, 2011 (JP) 2011-182322

(51) Int. Cl. H04N 5/445; H04N 13/04

(52) U.S. Cl. CPC H04N 5/44543; H04N 13/044
USPC 348/53; 348/563

(57) ABSTRACT

To appropriately prevent the occurrence of a burn-in phenomenon during a display of a video in which an OSD screen is superimposed on a video screen. By appropriately moving the position for displaying an OSD screen when the OSD screen is displayed on a video screen in a superimposed manner, a burn-in phenomenon is prevented from occurring in a menu background area of the OSD screen or a boundary portion between a menu background area and a menu phrase. For example, each time the OSD screen is displayed, the OSD screen is moved by one pixel and then displayed. Movement of the display position of the OSD screen is implemented by an instruction from an OSD display position control unit 215.

### TECHNICAL FIELD

The technology disclosed in this description relates to a display device and a display control method capable of preventing the occurrence of a burn-in phenomenon during a display of a video, and more particularly, to a display device and a display control method capable of preventing the occurrence of the burn-in phenomenon during a display of a video in which an OSD screen is superimposed on a video screen.

### BACKGROUND ART

A display device that is mounted on the head and used to view a video, that is, a head mount display (HMD) has been widely known. The head mount display includes left-eye and right-eye optical units, and is configured to control a visual sense and an auditory sense in conjunction with a headphone. The head mount display configured to completely block the outside world when mounted on the head implements increased virtual reality while viewing a video. Further, the head mount display can project different videos to the left and right eyes, and can provide a 3D image by displaying an image with parallax between the left and right eyes.

For example, a high-resolution display panel including a liquid crystal element or an electro-luminescence (EL) element may be used as left-eye and right-eye display units of a head mount display. Further, when an appropriate angle of view is set by an optical system and a multi-channel is reproduced by a headphone, a realistic sensation like when viewed in a movie theater can be reproduced.

In the industry, a display panel including a liquid crystal element, an organic EL element, or the like has been known to be likely to undergo the burn-in phenomenon in an area having a large brightness difference. When a still image such as an on screen display (OSD) screen is rendered to be superimposed on a video screen, an area having a large brightness difference occurs, and thus the burn-in phenomenon occurs in the area.

The head mount display has a limitation to the number of operation buttons mountable to a main body thereof, and thus a user operation using an OSD screen is inevitably required. Thus, even when the display panel of the above-mentioned type is used as the display device of the head mount display, significant consideration needs to be given to prevent the burn-in phenomenon from occurring when an OSD screen is displayed.

An OSD screen used to display a menu usually includes a menu background area and a menu phrase rendered on the background area. An OSD screen is basically a still image and is likely to have a large brightness difference. For this reason, when an OSD screen is displayed for a long time, the burn-in phenomenon occurs.

A video screen is configured with various video sources such as a moving image, and thus a brightness difference between pixels changes. For this reason, the burn-in phenomenon is reduced to some extent. On the other hand, since an OSD screen is a still image, an OSD screen is likely to undergo the burn-in phenomenon. In a boundary between a menu background area and an area for displaying a menu phrase, when a large brightness difference between still pixels is continued for a long time, the burn-in phenomenon is remarkably observed. Since a menu is often displayed such that the same phrase is repeatedly displayed, the burn-in is easily observed particularly in a boundary portion between the menu background area and a menu phrase.

For example, a liquid crystal display device has been proposed that prevents an afterimage phenomenon, in a state in which display content of the entire screen can be constantly determined, by sequentially moving pixels equally dispersed among pixels configuring a display screen and causing the moved pixels to display black (for example, see Patent Document 1).

Further, an organic light-emitting display device has been proposed that suppresses the burn-in from being observed even when the same image is displayed for a long time by moving a display position of the entire panel by a predetermined distance at predetermined time intervals (for example, see Patent Document 2).

Furthermore, a video display device has been proposed that prevents the burn-in by a process of lowering brightness of an OSD display (for example, see Patent Document 3).

However, in the above-mentioned related arts, it is difficult to prevent the burn-in phenomenon, particularly, in the boundary portion between the menu background area and the menu phrase. Since a video screen on which an OSD screen is not superimposed is configured with various video sources such as a moving image, the video screen is intrinsically unlikely to undergo the burn-in phenomenon. Nevertheless, when a pixel displaying black on a video screen is inserted, a screen of the video screen becomes dark, and the image quality degrades. Further, when the display position of the entire panel is moved by a predetermined distance at predetermined time intervals, the image quality of the video screen degrades, causing complaints to manufacturers. Furthermore, when the brightness of the OSD display is lowered, the OSD screen is not easily visible.

### CITATION LIST

### Patent Document

Patent Document 1: Japanese Patent Application Laid-Open No. 2009-134188
Patent Document 2: Japanese Patent Application Laid-Open No. 2007-304318
Patent Document 3: Japanese Patent Application Laid-Open No. 2011-81178

### SUMMARY

### Problems to be Solved

It is an object of the technology disclosed in this description to provide a display device and a display control method, which are excellent and capable of appropriately preventing the burn-in phenomenon from occurring during a display of a video in which an OSD screen is superimposed on a video screen.

### Solutions to Problems

The present disclosure has been made in light of the above problems, and a technology according to claim 1 provides a display method comprising: displaying an on-screen display image on a screen and changing the screen position of the on-screen display image at a predetermined timing the screen to be refreshed.

According to a technology recited in claim 2 of the present disclosure, The method as recited in claim 1, wherein changing the screen position comprises moving the on-screen image by one pixel.

According to a technology recited in claim 3 of the present disclosure, the method as recited in claim 1, wherein changing the screen position comprises moving the on-screen image along a locus which comprises multiple positions.

According to a technology recited in claim 4 of the present disclosure, the method as recited in claim 3, wherein the multiple positions of the locus are spaced one pixel apart, and moving the on-screen image along the locus comprises moving the on-screen image by one pixel.

A technology according to claim 5 of the present disclosure, the method as recited in claim 3, wherein the number of multiple positions is greater than two.

According to a technology recited in claim 6 of the present disclosure, the method as recited in claim 3, wherein the number of multiple positions is greater than four.

According to a technology recited in claim 7 of the present disclosure, the method as recited in claim 3, wherein the number of multiple positions is greater than eight.

According to a technology recited in claim 8 of the present disclosure, the method as recited in claim 1, wherein displaying the on-screen display image comprises displaying the on-screen display image superimposed on a moving image.

### Effects

According to the technology disclosed in this description, it is possible to provide a display device and a display control method, which are excellent and capable of appropriately preventing the burn-in phenomenon from occurring during a display of a video in which an OSD screen is superimposed on a video screen.

According to the technology disclosed in this description, by appropriately moving the position for displaying an OSD screen when the OSD screen is displayed on a video screen in a superimposed manner, it is possible to prevent the burn-in phenomenon from occurring in the menu background area of the OSD screen or the boundary portion between the menu background area and the menu phrase.

Other objects, features, and advantages of the technology disclosed in this description will become apparent from the detailed description based on embodiments which will be described later and the accompanying drawings.

### BRIEF DESCRIPTION OF DRAWINGS

FIG. 1 is a diagram schematically illustrating a configuration of an image display system including a head mount display.

FIG. 2 is a diagram schematically illustrating an internal configuration of a head mount display 10.

FIG. 3 is a diagram schematically illustrating an aspect in which a left-eye video and a right-eye video respectively displayed on display panels 224 and 225 are viewed with the user's both eyes and then fused in the user's brain.

FIG. 4 is a diagram illustrating an aspect in which a burn-in phenomenon occurs in a display panel that displays a video screen on which a menu screen in which a menu phrase is rendered on a menu background area is superimposed.

FIG. 5 is a diagram schematically illustrating an aspect in which each time an OSD screen is displayed, a display position of the OSD screen is moved by one pixel, and then the OSD screen is displayed.

FIG. 6 is a diagram illustrating an example of a locus for moving a display position of an OSD screen.

FIG. 7A is a diagram illustrating an example of moving a display position of an OSD screen according to the locus illustrated in FIG. 6.

FIG. 7B is a diagram illustrating an example of moving a display position of an OSD screen according to the locus illustrated in FIG. 6.

FIG. 8A is a diagram illustrating another example of moving a display position of an OSD screen according to the locus illustrated in FIG. 6.

FIG. 8B is a diagram illustrating another example of moving a display position of an OSD screen according to the locus illustrated in FIG. 6.

FIG. 9 is a diagram illustrating a comparison between an example in which an OSD screen is moved by one pixel and an example in which an OSD screen is not moved when a simulation result of a brightness variation is displayed.

FIG. 10 is a diagram illustrating a comparison between an example in which an OSD screen is moved by one pixel and an example in which an OSD screen is not moved when a brightness difference between neighboring pixels at each pixel position N is displayed.

### MODE FOR CARRYING OUT

Hereinafter, embodiments of the technology disclosed in this description will be described in detail with reference to the accompanying drawings.

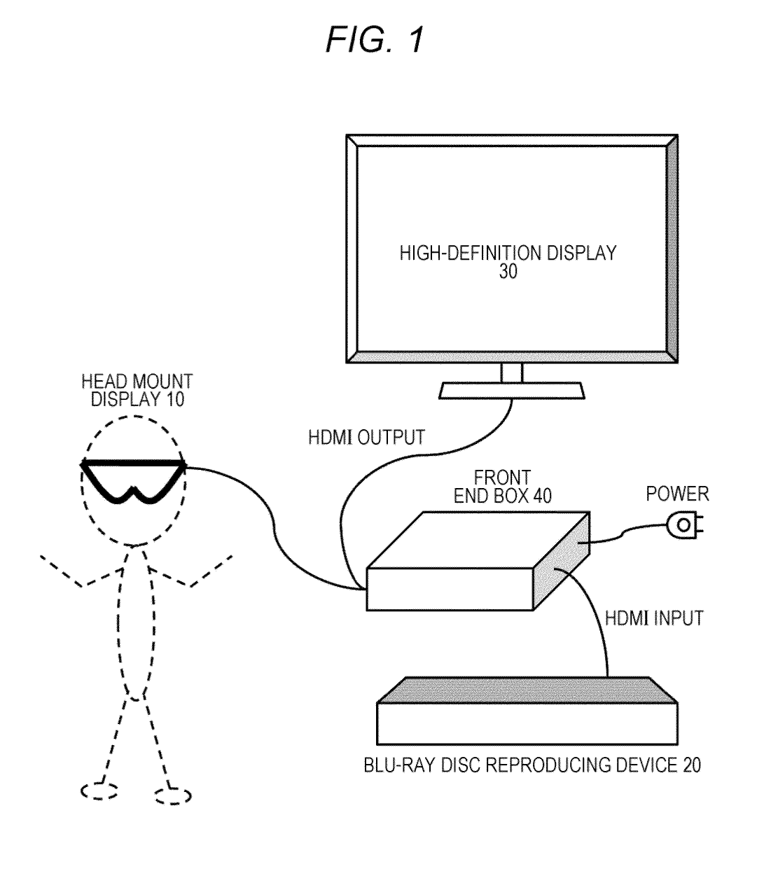

FIG. 1 schematically illustrates a configuration of an image display system including a head mount display. The system illustrated in FIG. 1 includes a main body of the head mount display 10, a Blu-ray disc reproducing device 20 which is a source of viewing content, a high-definition display (for example, a television supporting an HDMI) 30 which is another output destination of reproduction content of the Blu-ray disc reproducing device 20, and a front end box 40 that processes an AV signal output from the Blu-ray disc reproducing device 20.

The front end box 40 corresponds to an HDMI repeater that receives an AV signal output from the Blu-ray disc reproducing device 20 through an HDMI, performs, for example, signal processing, and outputs the signal processing result through an HDMI. The front end box 40 also functions as a two-output switcher that switches an output destination of the Blu-ray disc reproducing device 20 to either the head mount display 10 or the high-definition display 30. In the illustrated example, the front end box 40 has two outputs but may have three or more outputs. The front end box 40 exclusively sets an output destination of an AV signal and gives a priority to an output to the head mount display 10.

The high-definition multimedia interface (HDMI) refers to an interface standard for digital home electronics which is based on a digital visual interface (DVI) and mainly used to transmit a sound and a video. Transition minimized differential signaling (TMDS) is used in a physical layer of the HDMI. For example, the present system conforms to HDMI1.4.

The Blu-ray disc reproducing device 20 is connected to the front end box 40 through an HDMI cable, and the front end box 40 is connected to the high-definition display 30 through an HDMI cable. The front end box 40 can be connected to the head mount display 10 through an HDMI cable, but an AV signal may be serially transferred using any other cable. However, an AV signal and power may be supplied through a single cable that connects the front end box 40 with the head mount display 10, and in this case, the head mount display 10 can be supplied with drive power through this cable.

The head mount display 10 includes left-eye and right-eye display units which are independent of each other. For example, an organic EL element may be used as each display unit. Each of the left and right display units includes a wide viewing angle optical system of a low strain and high resolution.

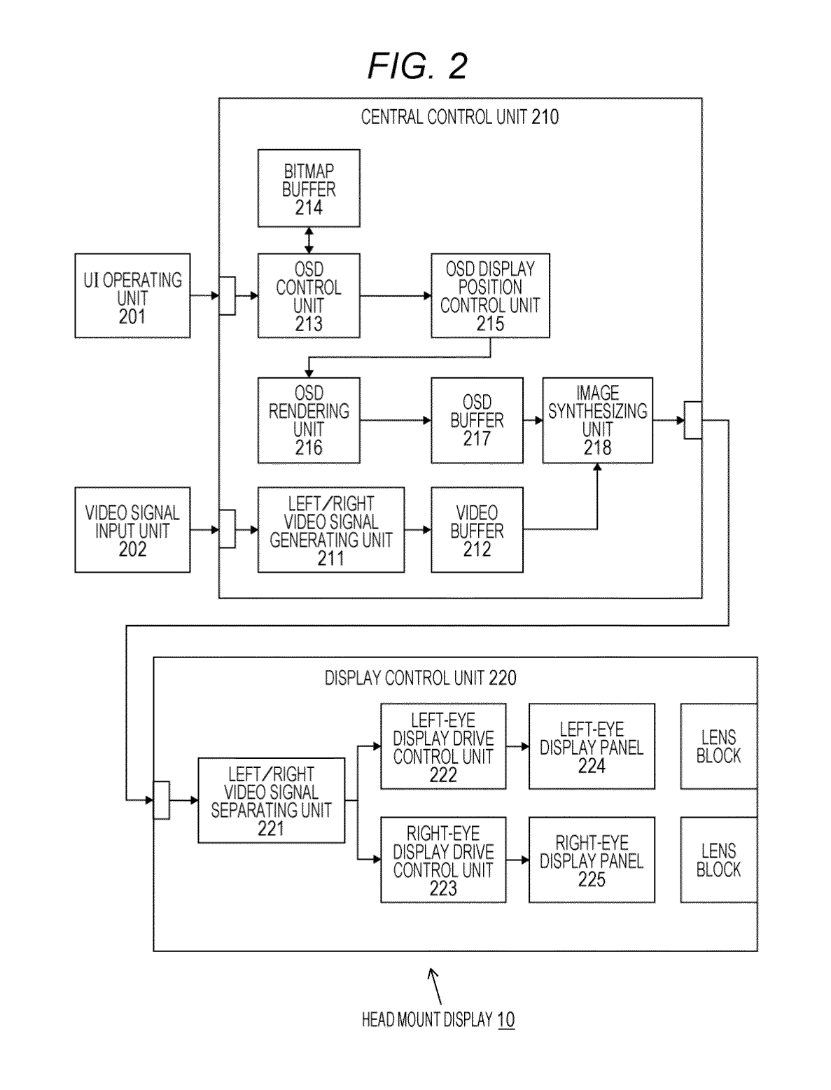

FIG. 2 schematically illustrates an internal configuration of the head mount display 10. The head mount display illustrated in FIG. 2 includes a user interface (UI) operating unit 201, a video signal input unit 202, a central control unit 210, and a display control unit 220.

The video signal input unit 202 receives a video signal which is reproduced and output from the Blu-ray disc reproducing device 20 through the front end box 40.

Inside the central control unit 210, a left/right video signal generating unit 211 generates a left/right video signal in which a left-eye video signal is mixed with a right-eye video signal from an input video signal, and writes the left/right video signal in a video buffer 212.

The UI operating unit 201 receives a user's operation made through a button or the like. Inside the central control unit 210, an OSD control unit 213 reads image data of a corresponding menu from a bitmap buffer 214 in response to an UI operation, and generates an OSD screen. An OSD display position control unit 215 controls the display position of the OSD screen, and an OSD rendering unit 216 writes image data of the OSD screen at a corresponding position of an OSD buffer 217. For example, the OSD screen is a menu screen including a menu background area and a menu phrase.

Then, an image synthesizing unit 218 superimposes the OSD screen written in the OSD buffer 217 on the image data written in the video buffer 212 at the position designated by the ODS display position control unit 215, and outputs the resultant data to the display control unit 220.

Inside the display control unit 220, a left/right video signal separating unit 221 first separates an input left/right video signal into a left-eye video signal and a right-eye video signal. Then, a left-eye display drive control unit 222 performs control such that the left-eye video signal is rendered on a left-eye display panel 224. Further, a right-eye display drive control unit 223 performs control such that the right-eye video signal is rendered on a right-eye display panel 225. For example, each of the display panels 224 and 225 may include a display device such as an organic EL element or an LCD. Each of the left-eye display panel 224 and the right-eye display panel 225 includes a lens block that enlarges a video. Each of the left and right lens blocks includes a combination of a plurality of optical lenses and performs optical processing on a video to be displayed on the display panels 224 and 225. A video displayed on a light-emitting surface of each of the display panels 224 and 225 is enlarged while passing through the lens block and then forms a large virtual image on the user's retina. A left-eye video and a right-eye video are fused in the brain of the observing user.

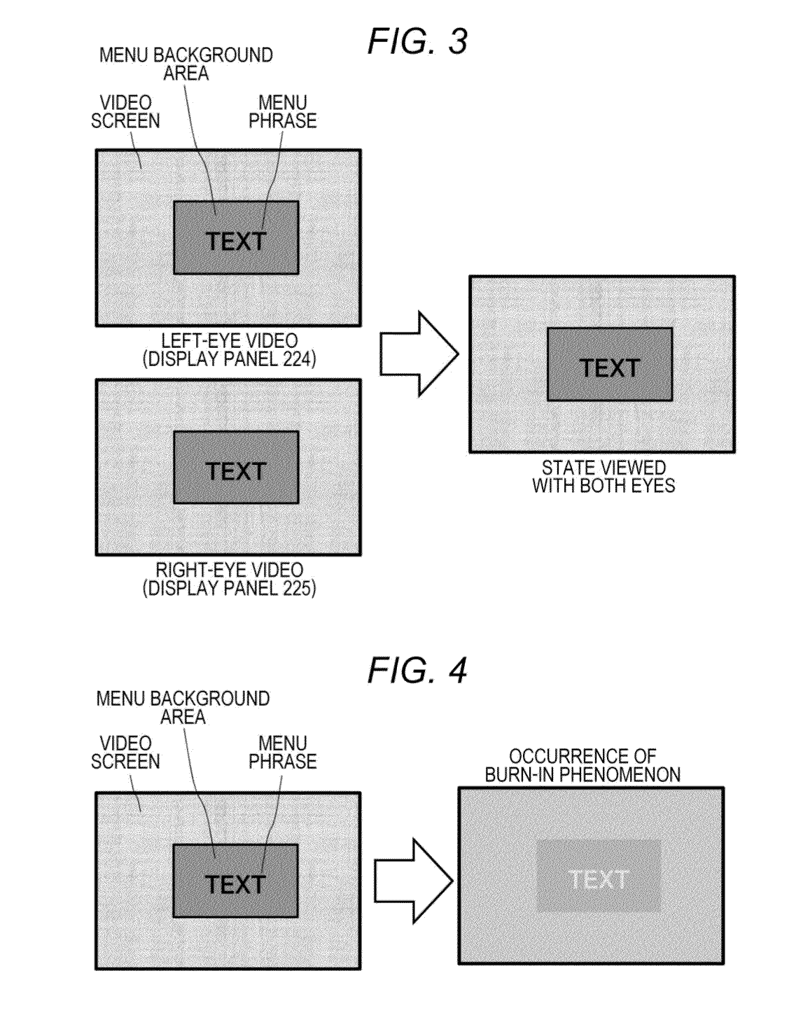

FIG. 3 schematically illustrates an aspect in which a left-eye video and a right-eye video displayed on the display panels 224 and 225, respectively, are viewed with the user's both eyes, and then fused in the user's brain. In the illustrated example, OSD screens are superimposed on the left-eye video and the right-eye video, respectively, near the center of a video screen. The OSD screen is a menu screen in which a menu phrase (TEXT) is rendered on a menu background area. The menu screens are also fused together with the video screen when viewed with both eyes.

For example, the display panels 224 and 225 include a display device such as an organic EL element or an LCD. However, the display device of this type has a problem in that the burn-in phenomenon is likely to occur in an area having a large brightness difference. For example, when a still image such as the OSD screen is rendered to be superimposed on the video screen, since an area having a large brightness difference is present, the burn-in phenomenon occurs in this area. Particularly, when the OSD screen is a menu screen in which a menu phrase is rendered on a menu background area, a brightness difference between still pixels in a boundary between a menu background area and an area for displaying a menu phrase may remain large for a long time, and thus the burn-in phenomenon may remarkably occur. Meanwhile, a video screen on which an OSD screen is not superimposed is configured with various video sources such as a moving image and changes in a brightness difference between pixels. For this reason, the burn-in phenomenon is reduced to some extent.

FIG. 4 illustrates an aspect in which the burn-in phenomenon occurs in a display panel that displays a video screen on which a menu screen in which a menu phrase is rendered on a menu background area is superimposed. As illustrated in the right of FIG. 4, the burn-in phenomenon is remarkably observed in a boundary between a menu background area and a menu phrase.

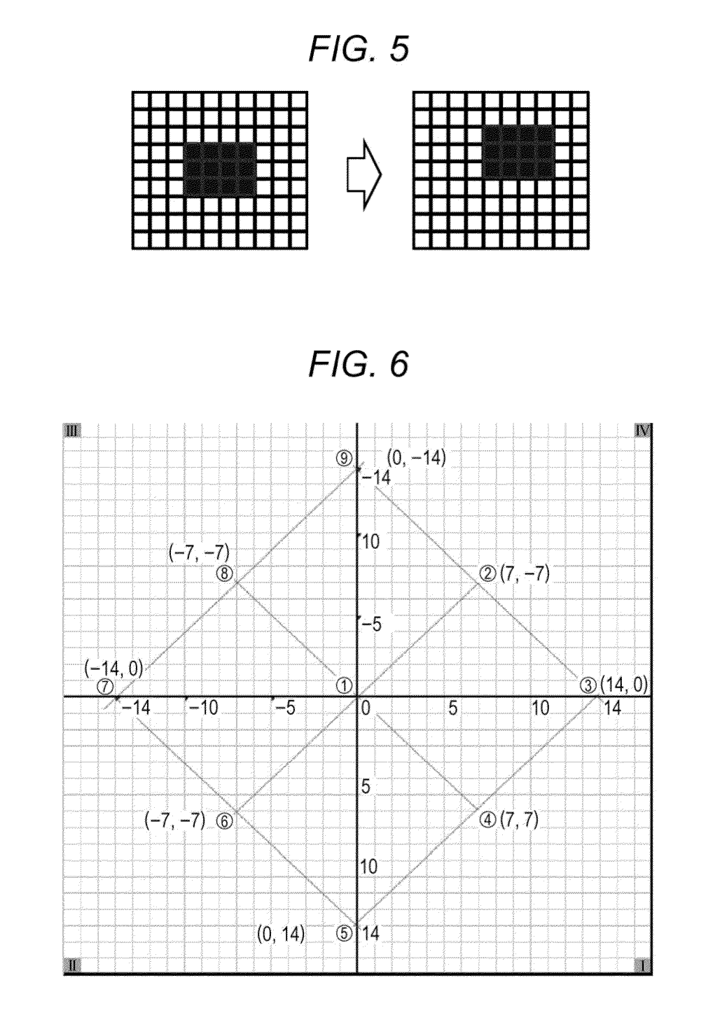

In this regard, in the technology disclosed in this description, when an OSD screen is displayed on a video screen in a superimposed manner, the position for displaying the OSD screen is appropriately moved, and thus the burn-in phenomenon can be prevented from occurring in a menu background area of the OSD screen or a boundary portion between a menu background area and a menu phrase. For example, each time the OSD screen is displayed, the display position of the OSD screen is moved by one pixel, and then the OSD screen is displayed. FIG. 5 schematically illustrates an aspect in which each time an OSD screen is displayed, a display position of the OSD screen is moved by one pixel, and then the OSD screen is displayed. The movement of the display position of the OSD screen is implemented by an instruction from the OSC display position control unit 215.

Orbit processing has been known that periodically deviates the whole image displayed on the display panel in order to blur a contour of the burn in to be indistinctive (for example, see Patent Document 2). However, from the applicant's point of view, it is inappropriate to move the whole screen due to the following reasons.

Since an OSD screen is a still image and has an area having a large brightness difference, the OSD screen is likely to undergo the burn-in phenomenon. However, since a video screen on which an OSD screen is not superimposed is configured with various video sources such as a moving image, the video screen is intrinsically unlikely to undergo the burn-in phenomenon. Nevertheless, when the whole screen is moved, the image quality of the video screen degrades, causing complaints to manufacturers. The OSD screen appears on the display panels 224 and 225 in response to an operation on the UI operating unit 201 but is not constantly displayed. When the whole screen is moved in a state in which the OSD screen is not displayed, the image quality of the video screen unnecessarily degrades.

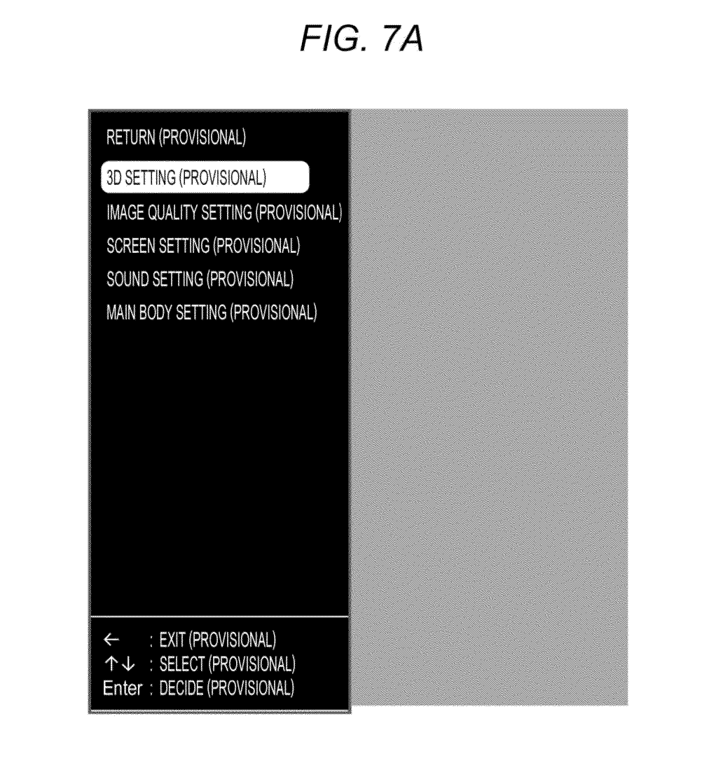

The OSD screen appears on the display panels 224 and 225 in response to an operation on the UI operating unit 201. Since then, the display position of the OSD screen is moved by one pixel based on a specific locus each time the screen is refreshed during the appearance of the OSD screen. FIG. 6 illustrates an example of a locus for moving the display position of the OSD screen. In FIG. 6, an initial position of the OSD screen is set to coordinates (0, 0), and a locus is represented as offset amounts from the initial position. When the screen finishes following a locus of \textcircled{2}→\textcircled{3}→\textcircled{4}→\textcircled{5}→\textcircled{6}→\textcircled{1}→\textcircled{4}→\textcircled{5}→\textcircled{6}→\textcircled{7}→\textcircled{8}→\textcircled{1}→\textcircled{6}→\textcircled{7}→\textcircled{8}→\textcircled{9}→\textcircled{2}→\textcircled{1}→\textcircled{8}→\textcircled{9}→\textcircled{2}→\textcircled{3}→\textcircled{4}, which starts from \textcircled{1}, the screen returns to \textcircled{1}. However, the gist of the technology disclosed in this description is not limited to a specific locus.

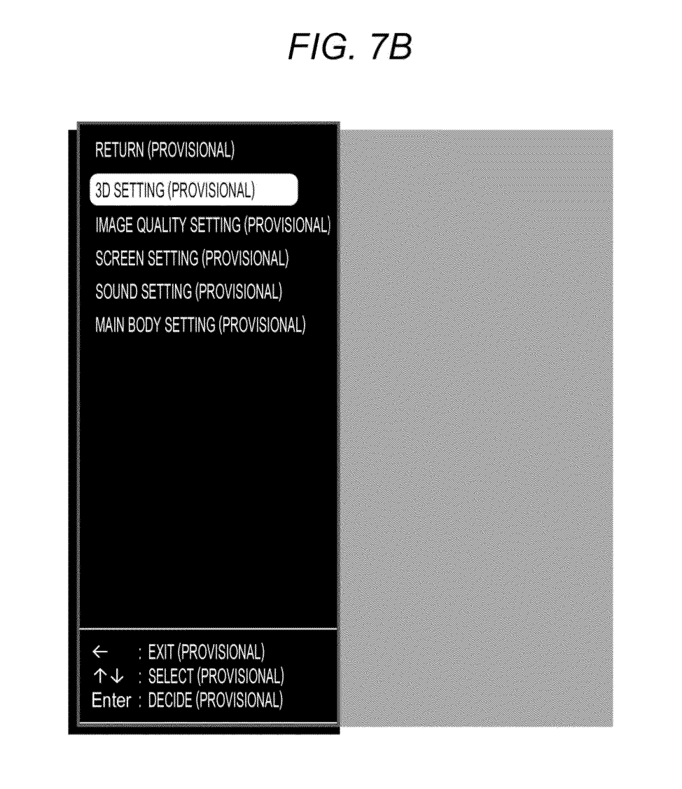

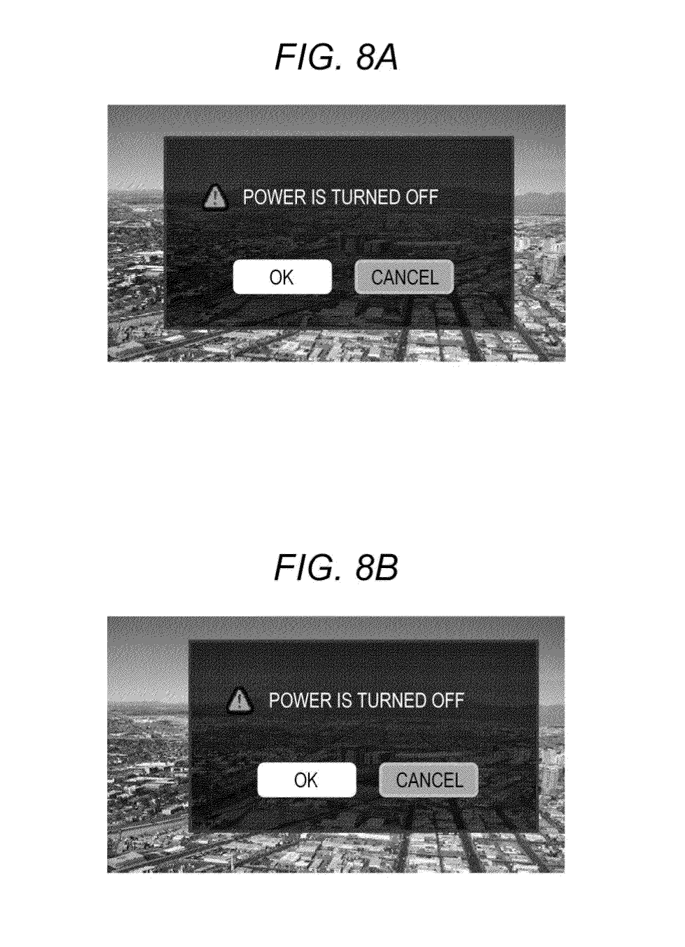

FIGS. 7A and 7B illustrate an example of moving the display position of the OSD screen according to the locus illustrated in FIG. 6. FIGS. 8A and 8B illustrate another example of moving the display position of the OSD screen according to the locus illustrated in FIG. 6.

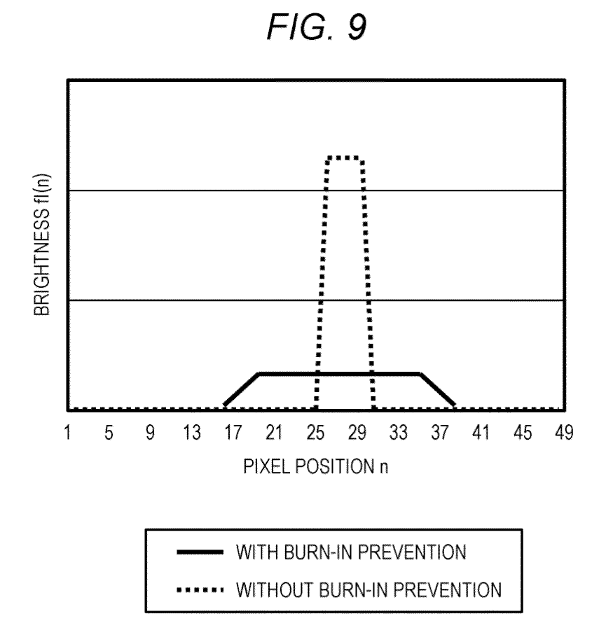

FIG. 9 illustrates a comparison between an example (with burn-in prevention) in which an OSD screen is moved by one pixel and an example (without burn-in prevention) in which an OSD screen is not moved when a simulation result of a brightness variation is displayed. In FIG. 9, a horizontal axis represents a pixel position n, and a vertical axis represents a brightness fl(n) at each pixel position n. Technically, fl does represent not brightness but a function that is proportionate to brightness. It can be understood from this simulation result that brightness degradation between neighboring pixels can be improved by 96.7% by moving the above-described OSD screen.

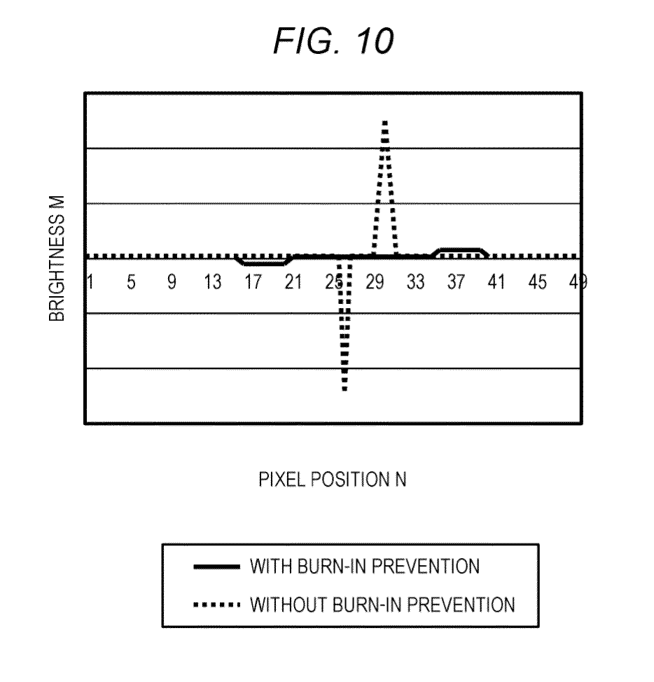

FIG. 10 illustrates a comparison between an example (with burn-in prevention) in which an OSD screen is moved by one pixel and an example (without burn-in prevention) in which an OSD screen is not moved when a simulation result of a brightness difference between neighboring pixels at each pixel position N is displayed. In FIG. 10, a horizontal axis represents a pixel position N, and a vertical axis represents a brightness difference M between neighboring pixels. The brightness difference M is defined as M=fl(N+1)−fl(N). It can be understood from this simulation result that a brightness difference between neighboring pixels is remarkably lowered by moving the above-described OSD screen, and thus the occurrence of a burn-in phenomenon can be prevented.

In the above-described simulation, the temperature is set to be constant, a current is set to be constant (a current control type display), an OSD display time interval dT is set to be constant. Further, fl(n) is a function that outputs a value proportionate to brightness under the assumption that the display panels 224 and 225 degrade by one (1) when a display is performed for the time dT.

The technology disclosed in this description may have the following configurations, (1) A display method comprising: displaying an on-screen display image on a screen and changing the screen position of the on-screen display image at a predetermined timing the screen to be refreshed.

(2) The method of (1), wherein changing the screen position comprises moving the on-screen image by one pixel.
(3) The method of (1), wherein changing the screen position comprises moving the on-screen image along a locus which comprises multiple positions.
(4) The method of (3), wherein the multiple positions of the locus are spaced one pixel apart, and moving the on-screen image along the locus comprises moving the on-screen image by one pixel.
(5) The method of (3), wherein the number of multiple positions is greater than two.
(6) The method of (3), wherein the number of multiple positions is greater than four.
(7) The method of (3), wherein the number of multiple positions is greater than eight.
(8) The method of (1), wherein displaying the on-screen display image comprises displaying the on-screen display image superimposed on a moving image.
(9) The method of (1), wherein the on-screen display image comprises a menu including text.
(10) The method of (1), wherein the on-screen display image is defined by a left-eye video signal and a right-eye video signal.
(11) The method of (10), wherein the left-eye video signal is communicated to a left-eye display panel, and the right-eye video signal is communicated to a right-eye display panel.
(12) The method of (11), wherein the left-eye display panel and the right-eye display panel are incorporated within a head mount display.
(13) An image display system comprising:

a control unit for generating an on-screen display image for display on a screen, and for changing the screen position of the on-screen display image at a predetermined timing the screen to be refreshed.

(14) The system of (13), wherein changing the screen position comprises moving the on-screen image by one pixel.
(15) The system of (13), wherein changing the screen position comprises moving the on-screen image along a locus which comprises multiple positions.
(16) The system of (15), wherein the multiple positions of the locus are spaced one pixel apart, and moving the on-screen image along the locus comprises moving the on-screen image by one pixel.
(17) The system of (13), wherein the on-screen display image is defined by a left-eye video signal and a right-eye video signal, and wherein the system further comprises:

a left-eye display panel; and

a right-eye display panel,

wherein the left-eye video signal is communicated to the left-eye display panel, and the right-eye video signal is communicated to the right-eye display panel.

(18) The system of (17), wherein the control unit, the left-eye display panel, and the right-eye display panel are incorporated within a head mount display.
(19) A non-transitory computer-readable medium having stored thereon a computer readable program for implementing a display method, the display method comprising:

displaying an on-screen display image on a screen and changing the screen position of the on-screen display image at a predetermined timing the screen to be refreshed.

(20) The medium of (19), wherein changing the screen position comprises moving the on-screen image by one pixel.

### INDUSTRIAL APPLICABILITY

The technology disclosed in this description has been described above in detail with reference to the specific embodiments. However, it is obvious that those skilled in the art can make modification or substitution of the embodiments in a range not departing from the gist of the technology disclosed in this description.

In this description, the technology disclosed in this description has been described in connection with the embodiment in which the head mount display is mainly applied. However, the gist of the technology disclosed in this description is not limited thereto. The technology disclosed in this description can be similarly applied to display devices of various types configured with display devices such as an LCD or an organic EF element which is likely to undergo the burn-in phenomenon.

In short, the technology disclosed in this description has been described in connection with the exemplary embodiments, and thus the content described in this description is not to be interpreted in a limited way. It is necessary to take claims into consideration in order to determine the gist of the technology disclosed in this description.

### REFERENCE SIGNS LIST

10 Head mount display
20 Blu-ray disc reproducing device
30 High-definition display
40 Front end box
201 UI operating unit
202 Video signal input unit
210 Central control unit
211 Left/right video signal generating unit
212 Video buffer
213 OSD control unit
214 Bitmap buffer
215 OSD display position control unit
216 OSD rendering unit
217 OSD buffer
218 Image synthesizing unit
220 Display control unit
221 Left/right video signal separating unit
222 Left-eye display drive control unit
223 Right-eye display drive control unit
224 Left-eye display panel
225 Right-eye display panel

1. A display method comprising:
displaying an on-screen display image on a screen and changing the screen position of the on-screen display image at a predetermined timing the screen to be refreshed.

2. The method as recited in claim 1, wherein changing the screen position comprises moving the on-screen image by one pixel.

3. The method as recited in claim 1, wherein changing the screen position comprises moving the on-screen image along a locus which comprises multiple positions.

4. The method as recited in claim 3, wherein the multiple positions of the locus are spaced one pixel apart, and moving the on-screen image along the locus comprises moving the on-screen image by one pixel.

5. The method as recited in claim 3, wherein the number of multiple positions is greater than two.

6. The method as recited in claim 3, wherein the number of multiple positions is greater than four.

7. The method as recited in claim 3, wherein the number of multiple positions is greater than eight.

8. The method as recited in claim 1, wherein displaying the on-screen display image comprises displaying the on-screen display image superimposed on a moving image.

9. The method as recited in claim 1, wherein the on-screen display image comprises a menu including text.

10. The method as recited in claim 1, wherein the on-screen display image is defined by a left-eye video signal and a right-eye video signal.

11. The method as recited in claim 10, wherein the left-eye video signal is communicated to a left-eye display panel, and the right-eye video signal is communicated to a right-eye display panel.

12. The method as recited in claim 11, wherein the left-eye display panel and the right-eye display panel are incorporated within a head mount display.

13. An image display system comprising:
a control unit for generating an on-screen display image for display on a screen, and for changing the screen position of the on-screen display image at a predetermined timing the screen to be refreshed.

14. The system as recited in claim 13, wherein changing the screen position comprises moving the on-screen image by one pixel.

15. The system as recited in claim 13, wherein changing the screen position comprises moving the on-screen image along a locus which comprises multiple positions.

16. The system recited in claim 15, wherein the multiple positions of the locus are spaced one pixel apart, and moving the on-screen image along the locus comprises moving the on-screen image by one pixel.

17. The system as recited in claim 13, wherein the on-screen display image is defined by a left-eye video signal and a right-eye video signal, and wherein the system further comprises:
a left-eye display panel; and
a right-eye display panel,
wherein the left-eye video signal is communicated to the left-eye display panel, and the right-eye video signal is communicated to the right-eye display panel.

18. The system as recited in claim 17, wherein the control unit, the left-eye display panel, and the right-eye display panel are incorporated within a head mount display.

19. A non-transitory computer-readable medium having stored thereon a computer readable program for implementing a display method, the display method comprising:
displaying an on-screen display image on a screen and changing the screen position of the on-screen display image at a predetermined timing the screen to be refreshed.

20. The medium as recited in claim 19, wherein changing the screen position comprises moving the on-screen image by one pixel.
